(19) United States
(12) Patent Application Publication
(10) Pub. No.: US 2002/0052834 A1
(43) Pub. Date: May 2, 2002

(54) On-line registration method for registration of employees by representative of employing organization

(75) Inventors: Katsuhisa Fukuda, Kawasaki (JP); Hiroshi Tsuji, Itami (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Hitachi, Ltd., Tokyo (JP)

(21) Appl. No.: 09/801,170

(22) Filed: Mar. 8, 2001

(30) Foreign Application Priority Data
Oct. 27, 2000 (JP) 2000-333539

(51) Int. Cl. G06F 17/60

(52) U.S. Cl. 705/38

(57) ABSTRACT

The prior art does not allow a juristic person to apply for membership on line to obtain access to a service.

The method proposed here is provided with

a function to issue a group ID which becomes immediately available for use upon provisional registration of a group profile by a representative of the group to apply for access to a service;

a function to tie up with a credit standing assessment function or a credit rating body to assess the credit standing of the group by using the group profile; and

a preparatory function for the representative to do necessary processing for gaining access to the service, such as registration of users, in parallel with the execution of the credit inquiry check.

The convenience for the organization is increased by the possibility to accomplish membership registration on line, and at the same time the supplier of the service benefits from increased ease to attract more members.

### BACKGROUND OF THE INVENTION

1. Field of the Invention

The present invention relates to a method of registration involved in an application for subscription to an onerous membership-based network business, and more particularly to an on-line sign-up method for on-line registration.

2. Description of the Related Art

A number of methods have been proposed for an individual to apply for membership to become eligible for the use of a network service by signing up for it on line, and one of them is disclosed in the JP A No. 114783/1997 (prior art).

In the prior art, there is disclosed an on-line sign-up method by which an individual accesses from his or her terminal via a network to a server providing a service, checks the conditions of use and, after consenting to the terms of subscription, registers on line his or her personal profile that the server requires for providing the service (name, age, address, credit card number and so on).

However, the prior art does not allow a company or any other organization to apply for membership on line. Conceivable reasons for the unavailability of an opportunity for any juristic person company, institution or group (hereinafter collectively referred to as an organization) to sign up for membership on line include the following circumstances.

(1) Registration by an organization is tantamount to registration for the use of a given service by employees, officers or members (hereinafter generally referred to as constituent persons), and the total sum of service fees would be proportional to the number of constituent persons allowed access to the service. The greater the number of constituent persons, namely the larger the organization, usually the greater the importance attached to credit rating. Therefore, the supplier of the service would run the risk of failing to collect the bills by making the service available to an organization before assessing its credit standing, and this seems to be the reason why no service is made available to an organization before establishing its credit rating.

(2) There is a considerable amount of work to be done by an organization before registering its constituent persons, who would be the substantial beneficiaries of the service, such as registering their profiles as prospective users and customizing the available service.

These problems have hindered the prior art from implementing an on-line sign-up tool, and resulted in a long period of time taken by a membership application by an organization until the desired service becomes actually available.

An object of the present invention is not only to reduce the risk of a service supplier (hereinafter referred to as a supplier) regarding the collection of service fees and other factors but also to make it possible to provide an attractive service to an organization without delay.

Another object of the invention is to provide a new member registration method (by on-line signing up) to the suppliers to organizations.

### BRIEF SUMMARY OF THE INVENTION

In order to achieve these objects, the present invention provides for the following configuration.

An on-line sign-up method is configured of:

a function to issue a group ID which becomes immediately available for use upon provisional registration of a group profile by a representative of the group to apply for access to a service;

a function to tie up with a credit inquiry function or a credit rating body to assess the credit standing of the group by using the group profile;

a preparatory function for the representative to do necessary processing for gaining access to the service in parallel with the execution of the credit inquiry check;

a profile confirmation function to have the preliminary processing reflected in a regular service after the completion of the credit inquiry check;

a function to supply the regular service; and

an ID authentication function to authenticate and control requests for service from the representative's and or individual users' IDs.

### BRIEF DESCRIPTION OF SEVERAL VIEWS OF THE DRAWINGS

The accompanying drawings, which are incorporated in and constitute a part of the specification, illustrate embodiments of the invention and, together with the description, serve to explain the principles of the invention.

FIG. 1 illustrates the configuration of on-line sign-up functions;

FIG. 2 illustrates the environment of use;

FIG. 3 illustrates an example of top page of the regular service;

FIG. 4 illustrates an example of screen stating the terms of the regular service;

FIG. 5 illustrates an example of screen for use in registering a group profile;

FIG. 6 illustrates an example of top page screen for a representative;

FIG. 7 illustrates an example of screen for use in registering a user profile;

FIG. 8 illustrates an example of screen for use in individually registering a user profile;

FIG. 9 illustrates an example of screen for use in collectively registering a user profile;

FIG. 10 illustrates an example of information on a cafeteria plan to be registered in advance; and

FIG. 11 charts a processing flow after the product of the credit standing assessment function.

### DETAILED DESCRIPTION OF THE INVENTION

The present invention will be described in detail below with reference to the accompanying drawings.

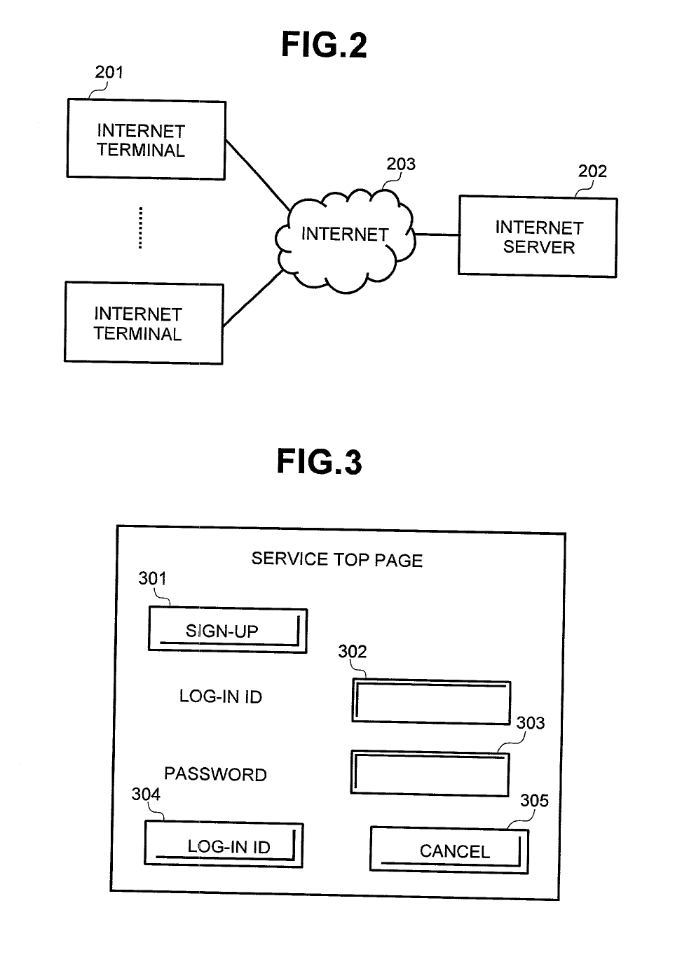

FIG. 2 illustrates a typical example of environment in which the invention is used. An Internet terminal (201) of a company (belonging to the category of an organization in this context) is connected to an Internet server (202) of a supplier providing services via Internet (203).

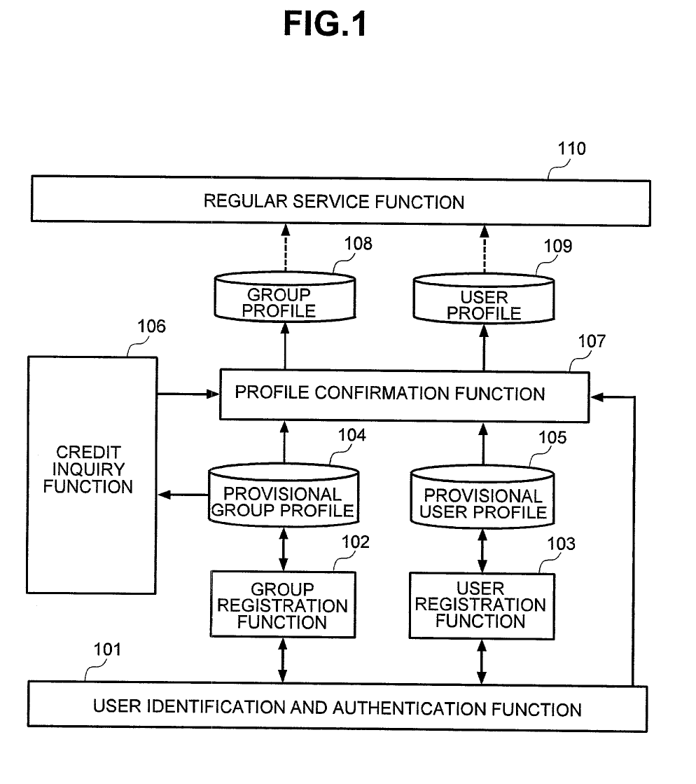

Functions for membership registration (on-line sign-up functions) with an Internet server (202 in FIG. 2) will be described with reference to FIG. 1. The on-line sign-up functions has a user identification and authentication function (101); a group registration function (102); a user registration function (103) as an example of preliminary work; a provisional group profile (104) for temporarily storing, before credit inquiry check, an organization having applied for membership; a provisional user profile (105) stored as an output of the preliminary work; a credit inquiry check function (106); a profile confirmation function (107) to make information available for the regular service after completion of the credit standing assessment; a group profile (108); a user profile (109); and a regular service function (110). The regular service in this context refers to the service available from the Internet server (202) as a full member.

The organization accesses from its Internet terminal (201) via Internet (203) the top page of the Internet server (202) of the supplier providing the desired service to sign up for the service on line. The natural person who physically takes charge of the organization's work for this purpose will be referred to as a representative in this context. Of course, the representative may be a third party entrusted by the organization to take charge of the work.

The Internet server (202) transmits to the Internet terminal (201) via Internet (203) the top page that is displayed when a user applies for its service. FIG. 3 illustrates an example of top page that is to be transmitted. In the example of FIG. 3, there are arranged a sign-up request button (301) for a person who is to newly apply for the service (registration as a member), a log-in ID input area (302) for a person who has already applied for membership and acquired an ID, a password input area (303), a log-in request button (304) and a cancel button (305).

A representative presses the sign-up request button (301) on the top page of FIG. 3 displayed on his or her Internet terminal (201), and thereby transmits a request for registration as a member on line (on-line sign-up request) to the Internet server (202) via Internet (203).

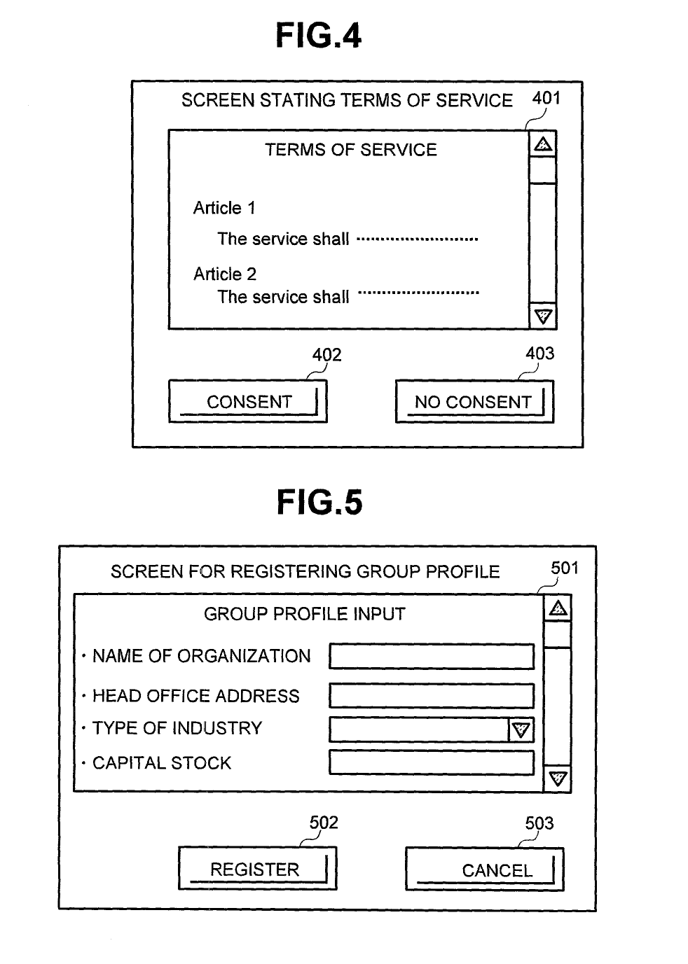

The Internet server (202), upon receipt of the on-line sign-up request, actuates its group registration function (102); reads out of a memory unit (not shown) the terms of subscription, rules of use and so forth for the service that is opted for by the request; transmits the information to the Internet terminal (201) from which the on-line sign-up request has come; and asks the representative of the organization to confirm and consent to the terms and the like. FIG. 4 illustrates an example of screen of the terms of subscription to be transmitted. In this example, the terms of service (401), a consent button (402) and a no consent button (403) are arranged.

The representative, after confirming the terms of service (401) displayed on the Internet terminal (201), presses the consent button (402) to notify via Internet (203) the Internet server (202) of his or her consent to the terms.

The group registration function (102) of the Internet server (202), upon confirmation of the consent of the organization's representative to the terms, transmits an actual group profile registration screen to the Internet terminal (201) via Internet (203). FIG. 5 illustrates an example of screen for use in registering a group profile to be transmitted. In this example, as necessary items of group profile for assessing the credit inquiry or identification of or liaison with the requesting organization, inputting of the name, head office address, type of Industry, equity capital stock and so forth of the organization using a group profile input area (501), register button (502) and cancel button (503) is requested. Other items of the group profile that may be inputted include the date of foundation, sales, proceeds of employees, main bank and method of payment.

The representative fills prescribed blanks of the group profile input area (501) displayed on the Internet terminal (201), presses the register button (502), and thereby transmits a request for registration of the group profile to the Internet server (202) via Internet (203). An expression “press a button” includes that click an icon on the screen by cursor. The information to be transmitted to the Internet server may be encrypted by a known encrypting technique before transmission.

The group registration function (102) of the Internet server (202), upon confirming that the representative has entered necessary items of the group profile for group registration and returned the information to the Internet server, and, after selecting the group ID and provisional password, newly registers the organization into the provisional group profile (104).

The required items for the registration need not include information on employees, but the items for identifying the requesting organization (name and head office address) would be required. The group ID and provisional password selected for the group profile are at the same time notified by electronic mail or paper mail to the representative of the requesting organization. The purpose of this parallel notification is to make sure that the representative really exists and that the representative (either in person or by proxy) has really applied for subscription. A written contract regarding the use of the service is also mailed. An electronic contract bearing an electronic signature may be substituted for the paper contract. Where the group profile registration function (102) includes a contract generating function, a contract into which registered information is incorporated on the basis of the registered group profile may be generated, and enclosed with a notification of the group ID and the like. Or an exclusive contract page which can be accessed only with that particular group ID and only for a prescribed period may be downloaded. In parallel with these actions, the group registration function (102) actuates the credit inquiry function, which assesses the credit standing of the organization on the basis of the inputted group profile. Finally, the Internet server (202) transmits the top page for subscription to the service (FIG. 3) to the Internet terminal (201) via Internet (203).

The representative acquires the group ID and provisional password by the above-described means. As the ID is immediately usable, the representative enters the group ID into the log-in ID input area (302) and the provisional password into the password input area (303), and transmits a log-in request to the Internet server (202) by pressing the log-in request button (304).

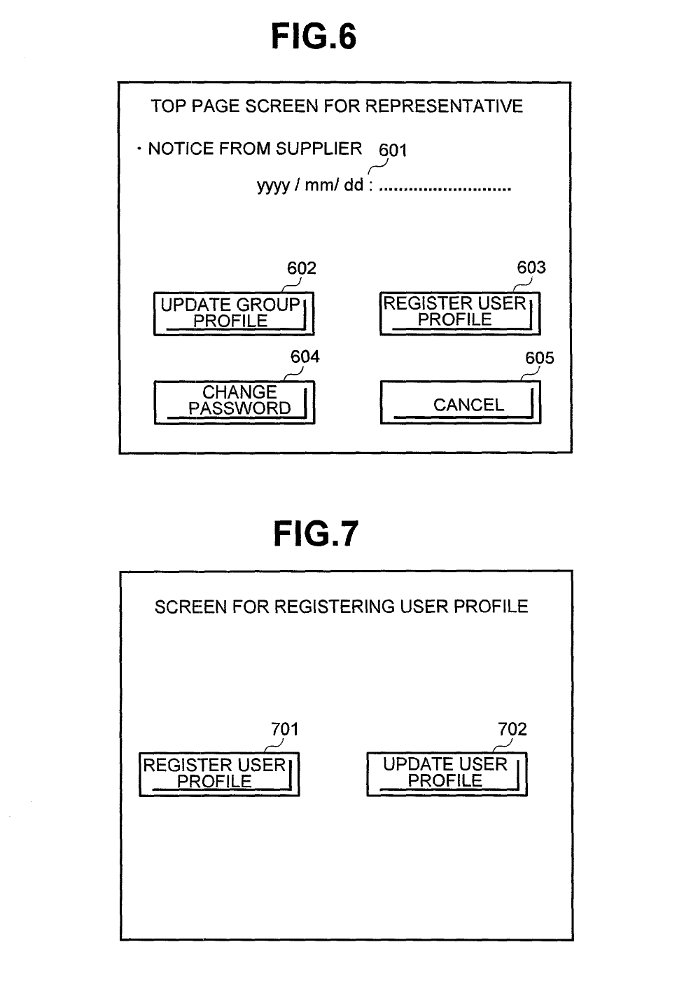

Upon receiving the log-in request, the user identification and authentication function (101) is executed at the internet server( 202) to confirm the transmitted log-in ID and password and to control the information to be transmitted. If the service supplier desires to reduce the risk further, it may also examine the expiration date of the contract set at the time of notifying the group ID and control the information to be transmitted. Further, in order to maintain security, it may set the expiration date of the password, also examine that expiration date, notify the expiration of the password in response to the log-in request, and transmit a password change screen to urge changing of the password. In doing so, the Internet server (202) may either control the expiration date of the password for itself or include it in the password for subsequent analysis and examination by the Internet server (202). In this particular case or providing a service, as the group ID and provisional password are already transmitted, the Internet server (202) transmits the top page for the representative to his or her Internet terminal (201). FIG. 6 illustrates an example of top page screen for a representative. In the screen of FIG. 6, there are arranged an area to display a notice from the service supplier (601) , an update request button for the group profile (602), a register request button for the user profile (603), a password change request button (604) and a cancel button (605). When the user profile register request button (603) is pressed, there appears a screen for the representative to input the name, post, title, telephone number and e-mail address of a user, i.e. an employee.

The representative, when it is desired to revise the group profile of the organization already registered with the Internet server (202), will press the group profile update request button (602) to register a group profile revision input such as the above-described or the desired date of revision processing. Or if is desired to change the already registered provisional or permanent password, the representative will register the change by pressing the password change request button (604).

The representative of a company, when a prospective user of the regular service is to be registered, presses the user profile register request button (603) to notify the Internet server (202) of a request to register a user profile. For security considerations, the user profile may be processed by a known encryption technique when it is notified to the Internet server. The Internet server (202), receives the request for user profile registration, the user registration function (102) is executed and a user registration page is transmitted to the company's Internet terminal. FIG. 7 illustrates an example of user registration request screen. In this example of screen, there are arranged a user profile register button (701) and a user profile update button (702).

The representative of an organization, when a prospective user of the regular service is to be newly registered, presses the user profile register button (701). Where the profile of a user of the regular service is to be updated, the representative presses the user profile update button (702) to notify the Internet server (202) of a request for user profile registration.

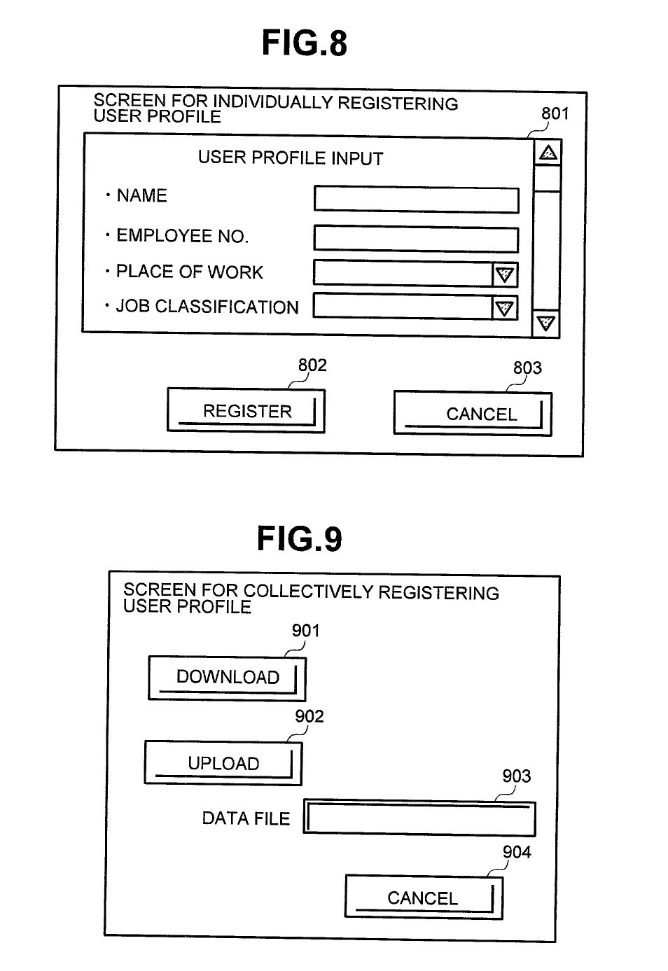

The Internet server (202), receives the request for user profile registration or the request for user profile revision, the user registration function (102) is executed and a page for individually registering a user is transmitted to the organization's Internet terminal. In some cases, a page for collectively registering users may be transmitted instead. In other cases a menu for the representative to choose between collective registration and individual registration may be transmitted. FIG. 8 illustrates an example of screen for individually registering a user profile. In this example of screen, there are arranged a user profile input area (801) for the name, reference no., place of employment, job classification, post, title, telephone number, e-mail address and so forth of an employee; a register button (802) and a cancel button (803). As mentioned above, a button means an icon on a computer screen. FIG. 9 illustrates an example of screen for collectively registering a user profile. In this example of screen, there are arranged a request button (901) for downloading a user profile registration data format, an upload registration data designation area (902), a collective register button (903) and a cancel button (904).

The representative, using appropriate ones of the above-mentioned means, transmits a user profile to the Internet server (202).

The Internet server (202), receiving the transmitted user profile, actuates the user registration function (102), checks prescribed points, and registers the transmitted profile as a provisional user profile into the provisional user profile.

After the group profile and the user profile have been registered as described above, the representative or the employee of the company then uses the profile confirmation function (107) as a preparatory step for using the regular service.

The profile confirmation function (107) is a function to receive mainly the result of assessment from the credit inquiry check function (106), check the validity of the result of assessment including the request concerning the processing data from the representative or the user, and generate a group profile (108) and a user profile (109) converted from the provisional group profile (104) and the provisional user profile (105) into forms demanded by the application services function (110).

Preliminary work is not confined to the registration of a user profile. The regular service has a function to develop a customized service out of a variety of service options and a parameter setting function, and may sometimes has a function to register in advance the products of those functions as provisional information to be confirmed and have them reflected in the actual regular service on the desired day of processing or upon approval by the representative.

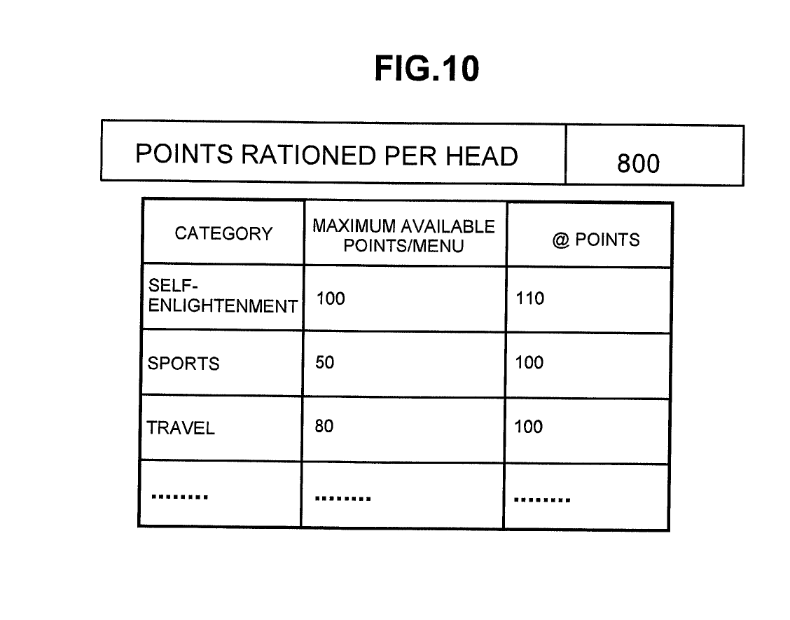

As an example of specific application needing such advance registration, there is a service to make available a benefits plan based on a cafeteria concept. Prospective users of this service are registered in advance, and it has to be set how many points can be assigned per employee, how many should be the maximum available points per menu, and how much should be the unit price of each menu in terms of points as tabulated in FIG. 10.

Note that such preliminary work can be done at virtually no cost to the supplier of the service, and can be executed irrespective of the assessment of the credit standing of the registering organization. For this reason, if such preliminary work can be done in advance of the start of service, it will be attractive to the prospective users. Also for the prospective users, the controllability of the timing at which the registered data are reflected is attractive from the viewpoint of the business activities of the company.

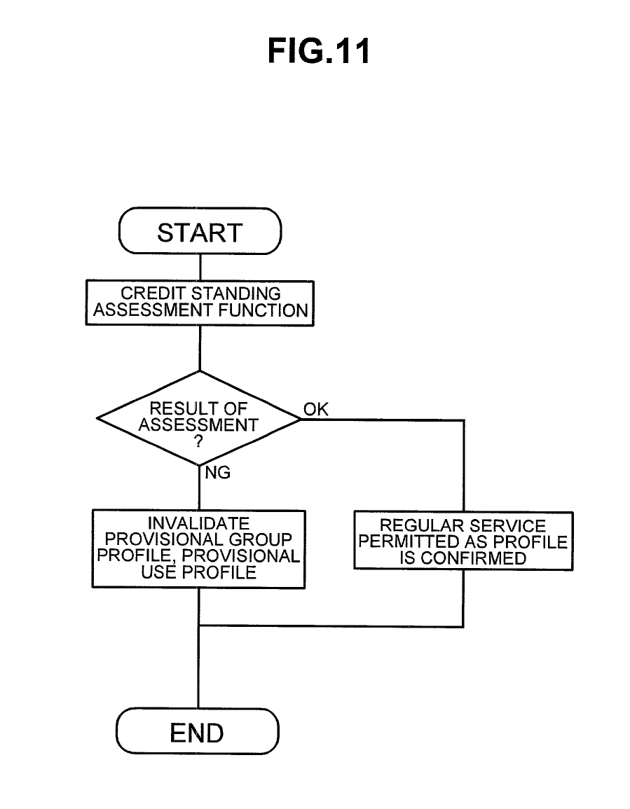

As shown in the flowchart of FIG. 11, if the profile confirmation function (107) should be notified by the credit standing assessment function (106) of a negative result of assessment, the profile confirmation function (107) would make the fact known to the representative of the organization concerned, and invalidate the provisional group profile (104) and the provisional user profile (105) managed by the Internet server (202). One of the conceivable methods of invalidation is to delete the information on the organization registered with the server or the ID issued to the organization. As a matter of principle, no group ID should be issued to such an organization failing to pass the assessment (unqualified organization), but where a group ID is to be issued to make the service available before the assessment of the credit inquiry of the organization as in the case of the present invention, some precaution should be taken to minimize the risk entailing from the use of the service by an organization which would prove unqualified. This need is met by the possibility to invalidate the group ID.

The present invention can significantly benefit both the supplier and the users of the service, the former by providing the advantage in building up a large membership and the latter by offering the early availability of an attractive service.

The present invention is not limited to the above embodiments and various changes and modifications can be made within the spirit and scope of the present invention. Therefore, to appraise the public of the scope of the present invention, the following claims are made.

1. A method for registering members of a group with a server that is configured to supply a service to a group via a communications network, comprising:
provisionally registering a group profile,
issuing a group ID that is available for use upon provisional registration of the group profile,
assessing credit worthiness of the group using information provided in the group profile,
allowing a group representative to perform preliminary processing for accessing the service concurrently with the step of assessing credit worthiness of the group,
reflecting the preliminary processing in the service after completing the step of assessing credit worthiness of the group to thereby maintain availability of the service,
providing the service, and
performing ID authentication to authenticate and control requests for service from at least one of the group representative and a member of the group.

2. The method of claim 1, wherein the preliminary processing comprises registering a plurality of group member profiles.

3. The method of claim 1, wherein the preliminary processing comprises customizing to allow selection of more than one of a plurality of services.

4. The method of claim 1, comprising generating a contract based on the group profile after provisionally registering the group profile and providing the contract to the group.

5. The method of claim 2, wherein registering at least one profile of at least one group member comprises at least one of individually and collectively registering, at least one of on line and off line, a user profile.

6. A method for registering members of a group with a server that is configured to supply a service to a group via a communications network, comprising:
sending group credit information from a communication terminal to the server via the network,
evaluating group credit worthiness in response to receipt by the server of the group credit information,
issuing to the group a group ID for use in applying for the service supplied by the server,
enabling group members to use the group ID to apply for the service before completing the step of evaluating group credit worthiness, and
registering information on the group received by the server from the communication terminal.

7. The method of claim 6, comprising registering at least one profile of at least one group member in response to an application by at least one group member to use the service.

8. The method of claim 7, wherein registering at least one profile of at least one group member comprises at least one of individually and collectively registering, at least one of on line and off line, information managed by the group.

9. A method for registering a group with a server that is configured to supply a service to a group via a communications network, comprising:
providing the server with information on the group via a communication terminal,
assessing credit worthiness of the group in response to information on the group provided to the server via the communication terminal,
issuing an ID to the group, the ID enabling use of the service by the group before completion of the assessment of credit worthiness of the group,
informing the group of the ID,
registering the ID with the server, and
deleting the ID from the server when the assessment of credit worthiness of the group is negative.
